(19) United States
(12) Patent Application Publication
(10) Pub. No.: US 2026/0034923 A1
(43) Pub. Date: Feb. 5, 2026

(54) VEHICLE SEAT

(71) Applicant: GRAMMER Aktiengesellschaft, Ursensollen (DE)

(72) Inventor: KONSTANTIN KRIVENKOV, Amberg (DE)

(21) Appl. No.: 19/251,237

(22) Filed: Jun. 26, 2025

(30) Foreign Application Priority Data
Aug. 2, 2024 (DE) 102024122159.3

(51) Int. Cl. B60N 2/68; B60N 2/015; F16B 25/00

(52) U.S. Cl. CPC B60N 2/68; F16B 25/0073; B60N 2/015

(57) ABSTRACT

A vehicle seat for commercial vehicles includes a support structure and at least one cushion member. The at least one cushion member is arranged on the support structure. The support structure includes at least one shell member. The at least one cushion member is formed from an integral foam material. The at least one cushion member is fastened to the at least one shell member by means of at least one fastening member of screw-like design. The at least one fastening member of screw-like design engages directly in the integral foam material.

### CROSS-REFERENCE TO RELATED APPLICATIONS

This application claims priority to German Patent Application 102024122159.3, filed on Aug. 2, 2024, the contents of which are incorporated by reference herein in their entirety.

### TECHNICAL FIELD

The invention relates to a vehicle seat for commercial vehicles comprising a support structure and at least one cushion member, wherein the at least one cushion member is arranged on the support structure.

### BACKGROUND

Fields of application for the present invention are, in particular, commercial vehicles without a cab or with an open cab. Such commercial vehicles can be, for example, ride-on lawn mowers, small tractors, forklift trucks and construction machinery. In such commercial vehicles, a simple, robust vehicle seat is usually desired. Typically, such vehicle seats have a support structure, such as a linkage. A cushion member is arranged on this support structure. A protective cover is arranged on the cushion member to protect it from mechanical and/or weather influences.

To attach the cushion member to the support structure, either an adhesive bond is provided between the cushion member and the support structure or insert elements are incorporated in the cushion member, by means of which a mechanical connection to the support structure can be realised. Such connection techniques are disadvantageous because they either require a complex and therefore more cost-intensive process or it is not possible to replace the cushion member due to the fixed connection to the support structure.

Furthermore, due to these types of connection, discarded vehicle seats cannot be fed into a recycling process, or only with great effort. The known vehicle seats are therefore not sufficiently sustainable.

The task of the present invention is to provide a vehicle seat which overcomes the disadvantages mentioned at the beginning.

### SUMMARY

The core idea of the invention is a vehicle seat for commercial vehicles comprising a support structure and at least one cushion member, wherein the at least one cushion member is arranged on the support structure, wherein the support structure comprises at least one shell member, wherein the at least one cushion member is formed from an integral foam material, wherein the at least one cushion member is fastened to the at least one shell member by means of at least one fastening member of screw-like design, wherein the at least one fastening member of screw-like design engages directly into the integral foam material.

Integral foams are foams with a comparatively large-pored interior and a compact surface with a closed outer skin. The robust, visco-plastic outer skin provides a high level of protection. The at least one cushion member is therefore extremely robust against mechanical influences and/or the effects of the weather. It is therefore not necessary to provide a protective cover. Advantageously, the at least one cushion member therefore has no cover. The integral foam is preferably a polyurethane (PUR) integral foam. Polyurethane is robust, permanently elastic, easy to clean and resistant to oils, solvents and many chemicals. The shape of the at least one cushion member and/or the nature of the outer skin can be predetermined by the mould during production.

The hardness of the polyurethane (PUR) can advantageously be varied by selecting the starting materials. Advantageously, the at least one cushion member has sufficient elasticity to enable comfortable sitting.

According to the invention, the at least one screw-like fastening member engages directly in the integral foam. The at least one screw-like fastening member is thus in direct contact with the integral foam. The at least one screw-like fastening member is designed in such a way that a sufficiently stable fastening between the support structure and the at least one cushion member is ensured. A direct, insert-free foam screw connection is thus provided. Due to the absence of inserts, the at least one cushion member is unmixed. This makes it easier to feed it into a recycling process. Since neither gluing nor the provision of inserts is necessary, production is also simplified, which reduces manufacturing costs.

According to a particularly preferred embodiment, there is a detachable positive connection between the at least one screw-like fastening member and the at least one cushion member. In addition to the simpler manufacturing process, the components of a discarded vehicle seat can also be separated in a simple manner by loosening the screw-like fastening members. In contrast to gluing, this type of separation is much simpler. The components can then be fed into a recycling releases as unmixed components.

According to a further preferred embodiment, the screw-like fastening member has a disc-shaped end section. The end section is preferably intended and designed to lie against the shell member. Preferably, the end section rests against a second surface of the shell member, which is opposite the first surface against which the at least one cushion member rests. Furthermore, a core section is preferably arranged on the disc-shaped end section. Preferably, the core section is at least partially essentially pin-shaped. The core section is advantageously formed integrally with the end section at a first end. The second end of the core section is preferably formed as a needle-shaped, conical tip.

According to a further preferred embodiment, the at least one shell member has at least one receptacle in which the screw-like fastening member is partially arranged. Preferably, the receptacle is T-shaped. The end section of the screw-like fastening member is arranged in a second section of the receptacle. The second section is formed as a countersink in the at least one shell member. The second section merges into a first section, which is an opening in the at least one shell member. The core section of the screw-like fastening member is arranged in the second section of the receptacle. Preferably, the receptacle is laterally open so that the end portion and the core portion of the screw-like fastening member can be pushed laterally into the receptacle.

According to a further preferred embodiment, an externally threaded section is arranged on the core section. Preferably, the externally threaded section is self-tapping. The externally threaded section is thus advantageously designed in such a way that it cuts the integral foam during screwing in. Advantageously, a positive fit is cut into the cushion member by screwing the at least one screw-like fastening member into the at least one cushion member. Advantageously, the positive fit can releaseed so that the at least one screw-like fastening member can be unscrewed from the at least one cushion member. Preferably, the external threaded section forms a helical thread.

According to a further preferred embodiment, the core section has a minor diameter and the externally threaded section has a pitch diameter. The minor diameter is the distance between the root of the thread, i.e. the lowest point of the thread, and the opposite root of the thread. The pitch diameter is defined as the diameter of an imaginary, geometrically ideal circular cylinder (flank cylinder) that cuts through the thread profile in such a way that the widths of the resulting profile valleys and peaks are equal. Preferably, the pitch diameter is at least a factor of 2, preferably at least a factor of 3, larger than the minor diameter. Further preferably, the pitch diameter is at least a factor of 4 larger than the minor diameter. Such a deep external thread ensures sufficient mechanical strength of the connection between the integral foam and the screw-like fastening member.

According to a further preferred embodiment, the screw-like fastening member has a conical shape. A major diameter of the screw-like fastening member thus tapers from the disc-shaped end section towards the second end of the core section.

According to a preferred embodiment, the support structure comprises a first shell member on which at least a first cushion member is arranged. Preferably, the support structure comprises a second shell member on which at least a second cushion member is arranged. Preferably, the first shell member and the at least one first cushion member form a seat part of the vehicle seat. It is conceivable that several first cushion members are arranged on the first shell member. Thus, the first shell member and the plurality of first cushion members would form the seat part of the vehicle seat. Preferably, the second shell member and the at least one second cushion member form a back part of the vehicle seat. It is also conceivable that a plurality of second cushion members are arranged on the second shell member. In this way, the second shell member and the multiple second cushion members would form the back part of the vehicle seat. The first shell member and the second shell member can be made of a dimensionally stable plastic or a metal.

The support structure can advantageously further comprise a support member to which the first shell member and the second shell member are attached. The support member can preferably be arranged on the body of the commercial vehicle. It would also be conceivable that the support member is designed in such a way that the back part can be tilted relative to the seat part. Preferably, an inclination adjustment device is provided, by means of which an inclination of the back part relative to the seat part can be adjusted.

According to a further preferred embodiment, the support structure comprises only a shell member on which at least a first cushion member and at least a second cushion member are arranged. Preferably, a first section of the shell member and the at least one first cushion member form a seat part of the vehicle seat. It is conceivable that several first cushion members are arranged on the first section of the shell member. Thus, the first section of the shell member and the plurality of first cushion members would form the seat part of the vehicle seat. Preferably, a second section of the shell member and the at least one second cushion member form a back part of the vehicle seat. It is conceivable that several second cushion members are arranged on the second section of the shell member. Thus, the second section of the shell member and the multiple second cushion members would form the back part of the vehicle seat. The shell member may be made of a dimensionally stable plastic or a metal.

According to a preferred embodiment, the vehicle seat has a short back section. With such a short back section, the back section does not extend over the shoulder area of the occupant. In the case of tractors or forklift trucks, it is often preferable that the back section does not extend to the shoulder area in an upright position. This allows the driver greater freedom of movement with regard to turning the upper body, which is advantageous when travelling backwards, for example.

Preferably, at least one cushion member extends along a height axis Z′, a width axis Y′ and along a longitudinal axis X′. The backrest element is provided on a rear section of the vehicle seat along the longitudinal axis X′. A front section of the vehicle seat along the longitudinal axis X′ faces forwards along the occupant's normal line of vision. If necessary, the front section points towards any controls of the commercial vehicle. The width axis Y′ extends the lateral boundaries of the vehicle seat.

According to a further preferred embodiment, the at least one cushion member has a main section and at least one projection section. Preferably, the at least one projection section protrudes beyond the main section. The main section forms the section that is in contact with the occupant. Preferably, the at least one fastening member in the form of a screw engages in the projection section. Further preferably, the at least one screw-like fastening member engages only in the projection section. This means that the fastening member in the form of a screw does not restrict the occupant's seating comfort in any way. The screw-like fastening member is therefore only provided in one area of the seat, namely the projection section, which makes no contribution to the upholstery of the occupant, but serves exclusively to hold or fasten the at least one cushion member. Advantageously, the projection section is designed in such a way that it has a greater hardness and/or a greater density than the main section. This can result in an improved hold of the fastening member, which is designed in the form of a screw.

According to a further preferred embodiment, the at least one shell member has at least one receptacle in which the at least one projection section is arranged. Preferably, the at least one trough-like receptacle is essentially complementary to the at least one projection section. By arranging the projection section in the trough-like receptacle, an additional hold of the at least one cushion member on the at least one shell member is achieved.

According to a further preferred embodiment, the at least one cushion member has a plurality of openings. By providing the openings, the contact area with the occupant's body is reduced. This enables passive cooling through the circulation of air. Furthermore, improved usability is achieved under poor weather working conditions, for example dirt or moisture, as there is less surface area for the accumulation of moisture or dirt. In addition, the mass of the at least one cushion member and correspondingly the manufacturing costs are reduced.

The task is further solved by a commercial vehicle with a vehicle seat according to one of the embodiments described above. The commercial vehicle can be equipped with all the features already described above in the context of the vehicle seat, either individually or in combination with one another, and vice versa.

The commercial vehicle is preferably a commercial vehicle without a cab or with an open cab. For example, the utility vehicle is a ride-on lawn mower, a tractor, a forklift truck or a construction vehicle.

According to a preferred embodiment, the vehicle seat is attached to the body of the commercial vehicle.

### BRIEF DESCRIPTION OF THE DRAWINGS

Further advantages, objectives and features of the present invention are explained with reference to the following description of the attached figures. Similar components may have the same reference signs in the various embodiments. It shows:

FIG. 1 a perspective view of the vehicle seat according to one embodiment;

FIG. 2 a front view of the vehicle seat according to one embodiment;

FIG. 3 a top view of the vehicle seat according to one embodiment;

FIG. 4 a sectional view of the vehicle seat according to one embodiment;

FIG. 5 a sectional view of a screw-like fastening member arranged in the cushion member according to one embodiment;

FIG. 6 a sectional view of a screw-like fastening member arranged in the cushion member according to one embodiment;

FIG. 7 a sectional view of the vehicle seat according to one embodiment;

FIG. 8 a sectional view of a screw-like fastening member arranged in the cushion member according to one embodiment;

FIG. 9 a sectional view of the vehicle seat according to one embodiment;

FIG. 10 an exploded view of the vehicle seat according to one embodiment; and

FIG. 11 a perspective view of the vehicle seat according to one embodiment;

In the figures, identical components are to be understood with the corresponding reference signs. For the sake of clarity, components may not be labelled with a reference sign in some figures, but have been designated elsewhere.

### DETAILED DESCRIPTION

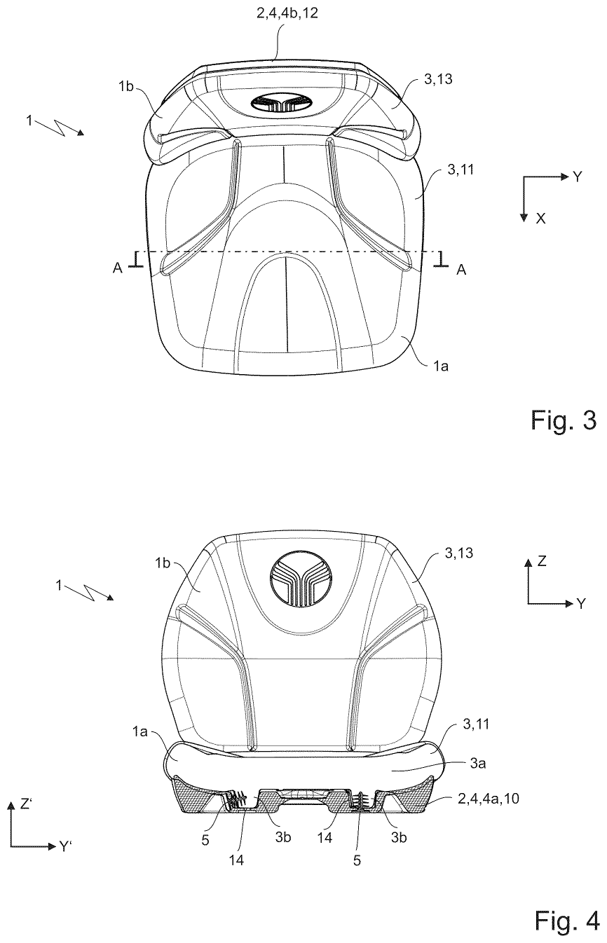

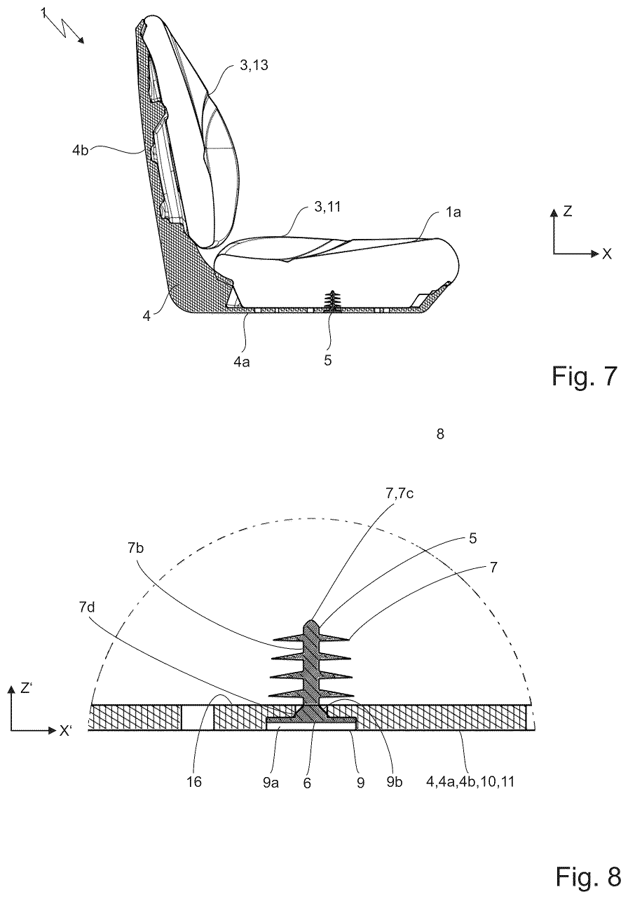

FIGS. 1 to 4, 7, 10, 11 show a vehicle seat 1 for commercial vehicles 100, comprising a support structure 2 and at least one cushion member 3, wherein the at least one cushion member 3 is arranged on the support structure 2, wherein the support structure 2 comprises at least one shell member 4, 10, 12, wherein the at least one cushion member 3 is formed from an integral foam material, wherein the at least one cushion member 3 is fastened to the at least one shell member 4 by means of at least one screw-like fastening member 5, wherein the at least one screw-like fastening member 5 engages directly into the integral foam material.

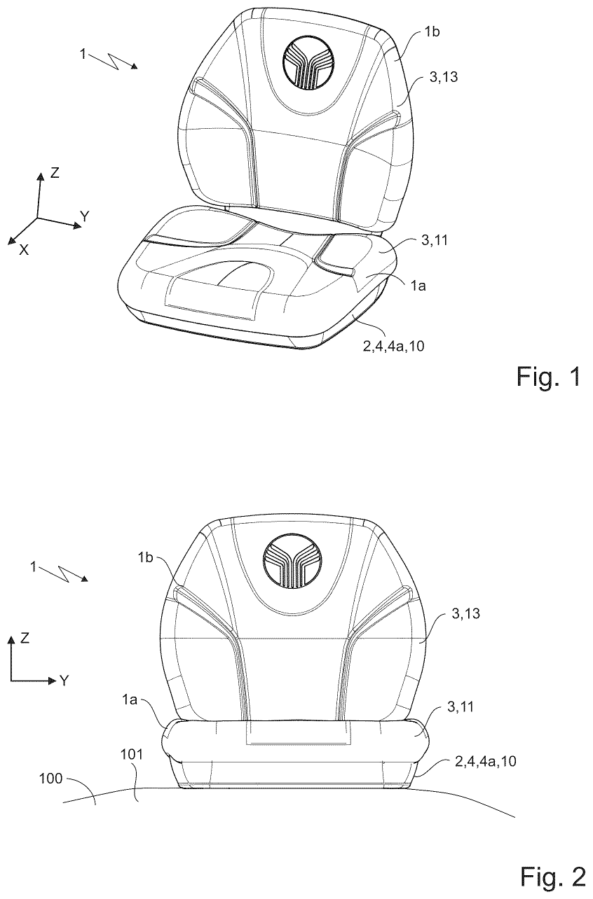

The vehicle seat extends along a longitudinal axis X, a width axis Y and a height axis Z. Advantageously, the vehicle seat 1 is attached to a section of the body 101 of a commercial vehicle 100. This is indicated in FIG. 2.

The vehicle seat 1 comprises a seat part 1a and a back part 1b. The support structure 2 can be designed in different ways:

According to one embodiment, the support structure 2 comprises a first shell member 10 and a second shell member 12. According to another embodiment, the support structure 2 comprises only one shell member 4.

According to the first embodiment, at least a first cushion member 11 is arranged on the first shell member 10. Furthermore, at least one second cushion member 13 is arranged on the second shell member 12. The first shell member 10 and the at least one first cushion member 11 form the seat part 1a of the vehicle seat 1. It is conceivable that several first cushion members 11 are arranged on the first shell member 10 and together form the seat part 1a. The second shell member 12 and the at least one second cushion member 13 form the back part 1b. It is conceivable that several second cushion members 13 are arranged on the second shell member 12 and together form the back part 1b. The two shell members 10, 12 can be connected to each other by means of a support member. This support member could be arranged on the body 101 of the commercial vehicle 100 and thus serve to attach the vehicle seat 1 to the body 101.

According to the further embodiment, only one shell member 4 is provided. The shell member 4 comprises a first section 4a and a second section 4b. The first section 4a, together with at least one first cushion member 11, forms the seat part 1a. It is conceivable that several first cushion members 11 are arranged on the first section 4a and together form the seat part 1a. The second section 4b forms the back part 1b together with the at least one second cushion member 13. It is conceivable that several second cushion members 13 are arranged on the second section 4b and together form the back part 1b. According to this embodiment, the shell member 4 can be arranged directly on the body 101. However, it would also be conceivable that a carrier element is provided, by means of which the attachment to the body 101 takes place.

The shell members 4, 10, 12 are so-called hard shells and are made of a dimensionally stable plastic or metal or metal alloy.

There is a detachable positive connection between the at least one screw-like fastening member 5 and the at least one cushion member 3. This detachable connection allows the at least one cushion member 3 to be removed from the at least one shell member 4, 10, 11 in a very simple manner. On the one hand, this has the advantage that the at least one cushion member 3 can be replaced in a simple manner. Furthermore, the components of a discarded vehicle seat 1 can be separated very easily. The separated components are then unmixed. This means, for example, that the at least one cushion member 3 does not contain any other elements, such as inserts, which need to be removed before a recycling process. The components can therefore be fed into a recycling process in a simple manner.

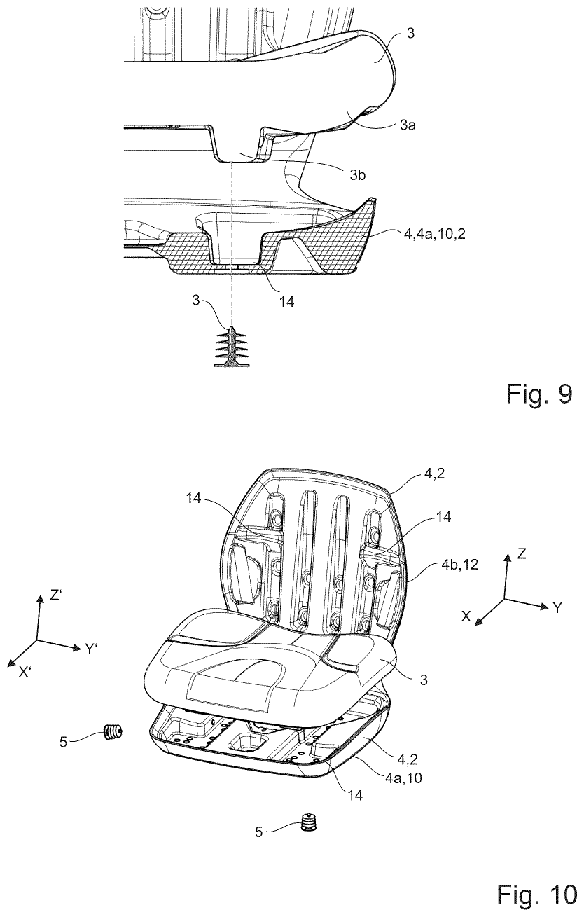

As can be seen in FIGS. 4, 5, 6, 8, 9 and 10, the screw-like fastening member 5 has a disc-shaped end section 6. A core section 7 is arranged on the disc-shaped end section 6. This core section 7 has a pin-like area 7b. At one end, this merges into a needle-shaped, conical tip 7c. At the opposite end, a pin-like area 7b merges into a transition area 7d, which is essentially conical in shape. The transition area 7d merges into the end section 6 of the screw-like fastening member 5.

A self-tapping external threaded section 8 is arranged on the core section 7. By screwing in the screw-like fastening member 5, a positive fit is thus cut into the integral foam. The core section 7 has a minor diameter 7a in its pin-like area 7b. The externally threaded section 8 has a pitch diameter 8a. The pitch diameter 8a is larger than the minor diameter 7a by at least a factor of 2, preferably by at least a factor of 3, more preferably by at least a factor of 4. Such a deep external threaded section 8 ensures mechanical strength of the positive connection between the screw-like fastening member 5 and the integral foam.

The respective flanks of the externally threaded section 8 preferably have a sawtooth shape. The respective flanks have a lower surface 8b, which faces the end section 6 and is essentially parallel to it. The lower surface 8b forms an angle with an upper surface 8c. This angle is an acute angle, which lies in a range between 2° and 10°.

The externally threaded section 8 further has a major diameter 8d, which is the maximum diameter of the externally threaded section 8. The major diameter 8d of the externally threaded section 8 advantageously decreases continuously in a direction starting from the end section 6 towards the tip 7c of the core section 7. The fastening member 5 thus preferably has a substantially conical shape.

The at least one screw-like fastening member 5 is arranged in a receptacle 9 of the shell member 4, 10, 11. The receptacle 9 has a first section 9a, in which the disc-shaped end section 6 is arranged. This first section 9a is adjoined by a second section 9b in the form of an opening through the shell member 4, 10, 11. The screw-like fastening member 5 protrudes through this opening. Preferably, part of the core section 7 is arranged in the opening. According to the embodiment, the core section 7 has a transition area 7d, in which the minor diameter increases in the direction of the end section 6. Preferably, this transition area 7d is conical in shape. The conical transition region 7d is partially in contact with an inner surface of the second section 9b in the form of an opening. The end section 6 lies against an inner surface of the first section. In a screwed-in state, the fastening member 5, which is shaped like a screw, is thus held by this contact of the end section 6 with the at least one cushion member 3. The at least one cushion member 3 then rests at least partially against an inner surface 16 of the shell member 4, 10, 11. The receptacle 9 is essentially T-shaped.

The at least one cushion member 3 extends along a height axis Z′, which corresponds to a thickness of the at least one cushion member 3. Furthermore, the at least one cushion member extends along a longitudinal axis X′ and a width axis Y′.

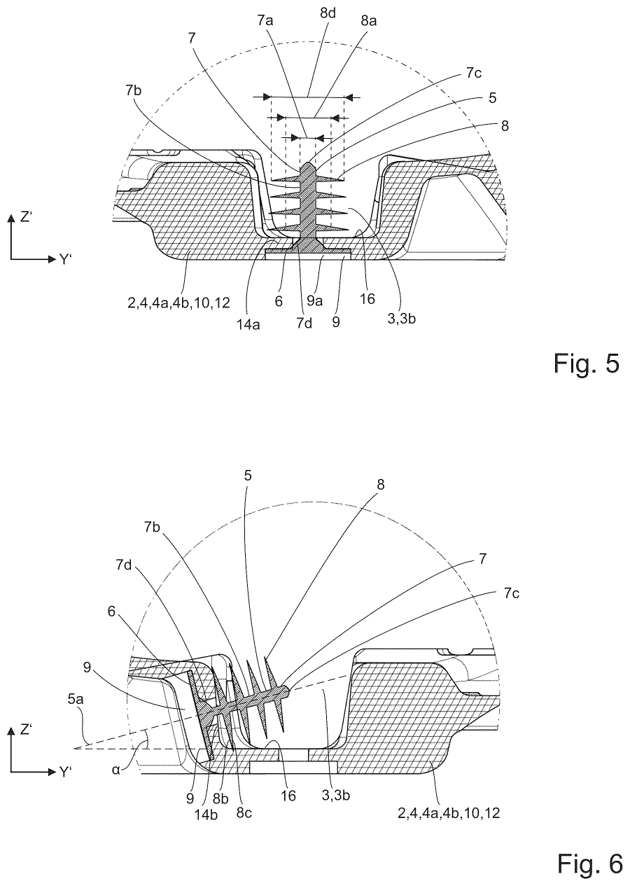

The screw-like fastening member 5 can be arranged in such a way that it extends essentially vertically, i.e. essentially along a height axis Z′, into the at least one cushion member 3. This is shown, for example, in FIG. 5 and FIG. 8. The screw-like fastening member 5 can also be screwed into the at least one cushion member 3 at an upward angle. A centre line 5a of the screw-like fastening member 5 thus forms an angle α with a plane spanned by the longitudinal axis X′ and the width axis Y′. This angle α is preferably in a range between 10 and 80°, more preferably in a range between 20° and 70°.

The at least one cushion member 3 can have a main section 3a and at least one projection section 3b. The main section 3a comprises the surface which is in contact with the occupant and the material portion of the cushion member 3 which is intended to provide the elasticity or cushioning. The main section 3a therefore has a certain thickness. The main section 3a can also have a varying thickness.

The main section 3a of a first cushion member 11, i.e. a cushion member for the seat part 1a, may have side carriages which serve to support the thighs of the occupant. The main section 3a of a second cushion member 13, i.e. a cushion member for the back section 1b, can have side carriages which serve to support the back of the occupant. Other configurations, such as curvatures etc., which promote ergonomic sitting would also be conceivable.

The at least one projection section 3b protrudes beyond the main section 3a. Preferably, the at least one projection section 3b protrudes beyond the main section 3a along the height axis Z′ of the at least one cushion member 3. The at least one screw-like fastening member 5 preferably engages exclusively in the projection section 7b. This has the advantage that the cushioning properties in the main section 3a of the at least one cushion member 3 are not impaired by the screw-like fastening member 5. It is also conceivable that the properties of the at least one cushion member 3 in the projection section 3b differ from the main section 3a. For example, the projection section 3b can have a greater hardness or density. This can provide an improved hold of the fastening member 5, which has a screw-like design.

In FIGS. 5 and 6, the fastening member 5 is arranged in the projection section 3b. In FIG. 5, the fastening member is arranged essentially vertically in the projection section 3b. In FIG. 6, the fastening member 5 is rotated into the projection section 3b at an angle. In contrast, no projection section is provided in FIG. 8. Here, the fastening member 11 is arranged in the main section 3a.

The at least one shell member 4, 10, 12 can have at least one trough-like receptacle 14. This receptacle-like receptacle 14 is provided and intended to receive at least one projection section 3b of the cushion member 3. Preferably, the at least one trough-like receptacle 14 is substantially complementary to the at least one projection section 3b. This preferably allows an additional positive fit to be realised, which provides an additional hold of the at least one cushion member 3 on the shell member 4.

In the embodiments shown in the figures, the projection sections 3b are essentially cylindrical in shape with a rectangular or square cross-section. Complementing this, the trough-like receptacles 14 also have a rectangular or square cross-section.

The trough-like receptacles 14 are clearly recognisable in FIGS. 4, 5, 6, 9 and 10. Of course, the trough-like receptacles 14 can be provided both in the first section 4a and in the second section 4b of a one-piece shell member 4 as well as in the first shell member 10 and the second shell member 12.

The at least one receptacle 9 for the screw-like fastening member 5 can be arranged in the trough-like receptacles 14. In the embodiment according to FIG. 5, the screw-like fastening member 5 projects vertically into the projection section 3b. The receptacle 9 is arranged in a lower wall 14a, which lies in a plane spanned by the width axis Y′ and the longitudinal axis X′. In the embodiment shown in FIG. 6, the screw-like fastening member 5 projects obliquely upwards into the projection section 3b. The receptacle 9 is arranged in a lateral wall 14b, which is essentially perpendicular to the lower wall 14a.

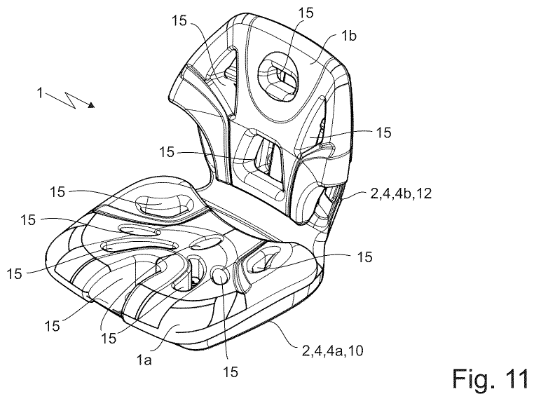

FIG. 11 shows an embodiment in which the at least one cushion member 3 has a plurality of openings 15. By providing the openings 15, the contact area with the occupant's body is reduced. This enables passive cooling through the circulation of air. Furthermore, improved usability is achieved under poor weather working conditions, for example dirt or moisture, as there is less surface area for the accumulation of moisture or dirt. In addition, the mass of the at least one cushion member and correspondingly the manufacturing costs are reduced.

The applicant reserves the right to claim all the features disclosed in the application documents as being essential to the invention, provided that they are new, either individually or in combination, compared with the prior art. It should also be noted that the individual figures also describe features which may be advantageous in themselves. The skilled person immediately recognises that a particular feature described in a figure can also be advantageous without the adoption of further features from this figure. Furthermore, the skilled person recognises that advantages can also result from a combination of several features shown in individual figures or in different figures.

### LIST OF REFERENCE SYMBOLS

1 Vehicle seat
2 Support structure
3 Cushion member
3a Main section of the cushion member
3b Projection section of the cushion member
4 Shell member
4a First section of the shell member
4b Second shell member
5 Fastening member
5a Centre line
6 End section of the fastening member
7 Core section of the fastening member
7a Minor diameter
7b Pin-shaped area of the core section
7c Tip of the core section
7d Transition area 7d of the core section
8 External thread section
8a Pitch diameter
8b Lower surfaces
8c Upper surfaces
8d Major diameter
9 Receptacle
10 First shell member
11 First cushion member
12 Second shell member
13 Second cushion member
14 Receptacle for the projection section
14a Lower wall of the receptacle
14b Lateral wall of the receptacle
15 Opening
16 Inner surface of the shell member
100 Commercial vehicle
101 Car body
α Angle
X Longitudinal axis of the vehicle seat
Y Width axis of the vehicle seat
Z Height axis of the vehicle seat
X Longitudinal axis of the cushion member
Y′ Width axis of the cushion member
Z′ Height axis of the cushion member

1. Vehicle seat (1) for commercial vehicles (100) comprising a support structure (2) and at least one cushion member (3), wherein the at least one cushion member (3) is arranged on the support structure (2), wherein
the support structure (2) comprises at least one shell member (4, 10, 12), wherein the at least one cushion member (3) is formed from an integral foam, wherein the at least one cushion member (3) is fastened to the at least one shell member (4) by means of at least one screw-like fastening member (5), wherein the at least one screw-like fastening member (5) engages directly into the integral foam material.

2. Vehicle seat (1) according to claim 1, wherein
there is a releasable positive connection between the at least one fastening member (5) of screw-like design and the at least one cushion member (3).

3. Vehicle seat (1) according to claim 1, wherein
the screw-like fastening member (5) has a disc-like end section (6), wherein a core section (7) is arranged on the disc-like end section (6), wherein the at least one shell member (5) has at least one receptacle (9) in which the screw-like fastening member (5) is partially arranged.

4. Vehicle seat (1) according to claim 3, wherein
an externally threaded section (8) is arranged on the core section (7), wherein the externally threaded section (8) is self-tapping, wherein the core section (7) has a minor diameter (7a) and the externally threaded section (8) has a pitch diameter (8a), wherein the pitch diameter (8a) is greater than the minor diameter (7a) by at least a factor of 2, preferably by at least a factor of 3.

5. Vehicle seat (1) according to claim 1,
wherein
the support structure (2) comprises a first shell member (10), on which at least one first cushion member (11) is arranged, wherein the support structure (2) comprises a second shell member (12), on which at least one second cushion member (13) is arranged, wherein the first shell member (10) and the at least one first cushion member (11) form a seat part (1a) of the vehicle seat (1), wherein the second shell member (12) and the at least one second cushion member (13) form a back part (1b) of the vehicle seat (1).

6. The vehicle seat (1) according to claim 1,
wherein
the support structure (2) comprises only one shell member (4), on which at least one first cushion member (11) and at least one second cushion member (13) are arranged, wherein a first section (4a) of the shell member (4) and the at least one first cushion member (11) form a seat part (1a) of the vehicle seat (1), wherein a second section (4b) of the shell member (4) and the at least one second cushion member (13) form a back part (1b) of the vehicle seat (1).
Vehicle seat (1) according to claim 1,
wherein
the at least one cushion member (3) has a main section (3a) and at least one projection section (3b), wherein the at least one projection section (3b) projects beyond the main section (3a), wherein the at least one fastening member (5) of screw-like design engages in the projection section (3b).

8. Vehicle seat (1) according to claim 7,
wherein
the at least one shell member (4, 10, 12) has at least one trough-like receptacle (14) in which the at least one projection section (3b) is arranged, wherein the at least one trough-like receptacle (14) is substantially complementary to the at least one projection section (3b).

9. The vehicle seat (1) according to claim 1,
wherein
the at least one cushion member (3) has a plurality of openings (15).

10. Commercial vehicle with a vehicle seat (1) according to claim 1.
